(19) United States
(12) Patent Application Publication
(10) Pub. No.: US 2025/0036926 A1
(43) Pub. Date: Jan. 30, 2025

(54) OPTIMIZATION METHOD OF LAYER-WISE POLYNOMIALS THROUGH DYNAMIC PROGRAMMING IN NEURAL NETWORK FOR FULLY HOMOMORPHIC ENCRYPTED DATA

(71) Applicants: Samsung Electronics Co., Ltd., Suwon-si (KR); Seoul National University R&DB Foundation, Seoul (KR); Industry-Academic Cooperation Foundation, Chosun University, Gwangju (KR); CHUNG ANG UNIVERSITY INDUSTRY ACADEMIC COOPERATION FOUNDATION, Seoul (KR); POSTECH RESEARCH AND BUSINESS DEVELOPMENT FOUNDATION, Pohang-si (KR)

(72) Inventors: Joon-Woo LEE, Seoul (KR); Junghyun LEE, Seoul (KR); Yongjune KIM, Pohang-si (KR); Young-Sik KIM, Gwangju (KR); Jong-Seon NO, Seoul (KR); Eunsang LEE, Seoul (KR)

(73) Assignees: Samsung Electronics Co., Ltd., Suwon-si (KR); Seoul National University R&DB Foundation, Seoul (KR); Industry-Academic Cooperation Foundation, Chosun University, Gwangju (KR); CHUNG ANG UNIVERSITY INDUSTRY ACADEMIC COOPERATION FOUNDATION, Seoul (KR); POSTECH RESEARCH AND BUSINESS DEVELOPMENT FOUNDATION, Pohang-si (KR)

(21) Appl. No.: 18/753,611

(22) Filed: Jun. 25, 2024

(30) Foreign Application Priority Data
Jul. 28, 2023 (KR) 10-2023-0099084
Oct. 31, 2023 (KR) 10-2023-0148538

(51) Int. Cl. G06N 3/048; G06F 11/07; G06F 17/17

(52) U.S. Cl. CPC G06N 3/048; G06F 11/0757; G06F 17/17

(57) ABSTRACT

An operation method of performing a neural network operation of fully homomorphic encrypted data is provided. The operation method includes: receiving data for performing the neural network operation and receiving a parameter for generating an approximation polynomial corresponding to the neural network operation; obtaining layer information corresponding to layers of a neural network model, the layer information based on the data; determining importances of the layers, respectively, wherein the determining of the importances is based on the parameter and the layer information; generating an approximation polynomial approximating the neural network operation for each of the layers, wherein the generating is based on the layer importance; and generating an operation result by performing the neural network operation based on the approximation polynomial, wherein the parameter includes a computation time condition that the neural network operation must satisfy.

### CROSS-REFERENCE TO RELATED APPLICATIONS

This application claims the benefit under 35 USC § 119(a) of Korean Patent Application No. 10-2023-0099084, filed on Jul. 28, 2023, and Korean Patent Application No. 10-2023-0148538, filed on Oct. 31, 2023, in the Korean Intellectual Property Office, the entire disclosures of which are incorporated herein by reference for all purposes.

### BACKGROUND

### 1. Field

The following description relates to a neural network operation apparatus of fully homomorphic encrypted data and a method thereof.

### 2. Description of Related Art

Homomorphic encryption is a promising encryption method that enables arbitrary operations between encrypted data while maintaining the decryptability of the encrypted data, even after the arbitrary operations are performed. Homomorphic encryption schemes enable arbitrary operations on encrypted data without having to decrypt the encrypted data.

Homomorphic encryption is generally lattice-based and thus resistant to quantum-computing based cryptoanalysis algorithms.

Regarding the arbitrary operations performable on homomorphically encrypted data, for such purpose, low order polynomials have been used as activation functions in neural networks that perform operations on fully homomorphic encrypted data. However, high order polynomials are generally preferred to accurately approximate a rectified linear unit (ReLU) to a polynomial in a neural network operation.

Due to computational requirements, when using a low order polynomial to perform a neural network operation on fully homomorphic encrypted data, a neural network may not be able to be deeply layered (e.g., may have a limited number of layers and relatively small numbers of nodes per layer), and high performance (e.g., accuracy) may not be achieved.

In a neural network operation for fully homomorphic encrypted data, since an activation function that is commonly used in neural networks (e.g., a ReLU function) may not be used, a pre-trained neural network may not be imported and used and a user may need to newly train a model.

In addition, since a high order polynomial is generally preferred to accurately approximate a ReLU to a polynomial, significant bootstrapping (a common homomorphic encryption technique) may be required to implement a fully homomorphic encryption operation in a deep neural network, thereby, excessive time consumption may be required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of performing a neural network operation, of a neural network model, on homomorphically encrypted data, by a computing device, includes: receiving data for performing the neural network operation and receiving a parameter for generating an approximation polynomial corresponding to the neural network operation; obtaining layer information corresponding to layers of the neural network model, the layer information based on the data; determining importances of the layers, respectively, wherein the determining of the importances is based on the parameter and the layer information; generating an approximation polynomial approximating the neural network operation for each of the layers, wherein the generating is based on the layer importance; and generating an operation result by performing the neural network operation based on the approximation polynomial, wherein the parameter includes a computation time condition that the neural network operation must satisfy.

The generating of the approximation polynomial may include determining a degree of the approximation polynomial based on the layer importances.

The obtaining of the layer information may include calculating, based on the data, a mean and a standard deviation of input data of a layer of the neural network model.

The determining of the layer importances may include: calculating an error between the neural network operation and the approximation polynomial based on the parameter, the mean, and the standard deviation; and determining a degree of the approximation polynomial based on the error.

The calculating of the error includes calculating a mean squared error between the neural network operation and the approximation polynomial using a weighted least square.

The method may further include determining whether the time condition is satisfied based on a time consumed for the neural network operation, which is determined based on the approximation polynomial.

The determining of the degree of the approximation polynomial may include, for each of the layers, determining a corresponding degree of the approximation polynomial that minimizes the error while satisfying the computation time condition.

The parameter may include a depth consumption condition of the neural network operation.

The neural network operation may include an activation function.

The neural network operation may include a rectified linear unit (ReLU) function.

The method may further include: determining a modulus chain corresponding to the layers based on the layer importances.

In another general aspect, an operation apparatus is for performing a neural network operation of a neural network model on homomorphically encrypted data, and the operation apparatus includes: one or more processors; memory storing data for performing the neural network operation, a parameter for generating an approximation polynomial for approximating the neural network operation, and instructions configured to cause the one or more processors to: obtain, based on the data, layer information corresponding to layers of the neural network model; determine, based on the parameter and the layer information, layer importances respectively corresponding to the layers; generate an approximation polynomial approximating the neural network operation for each of the plurality of layers, based on the layer importance; and generate an operation result by performing the neural network operation based on the approximation polynomial; wherein the parameter includes a computation time condition that is to be satisfied for the neural network operation.

The instructions may be further configured to cause the one or more processors to determine, based on the layer importances, a degree of the approximation polynomial.

The instructions may be further configured to cause the one or more processors to calculate a mean and a standard deviation of input data of a layer of the neural network, the input data based on the data.

The instructions may be further configured to cause the one or more processors to: calculate an error between the neural network operation and the approximation polynomial based on the parameter, the mean, and the standard deviation, and determine a degree of the approximation polynomial based on the error.

The instructions may be further configured to cause the one or more processors to calculate a mean squared error between the neural network operation and the approximation polynomial using a weighted least square.

The time condition may be determined based on a time consumed for the neural network operation based on the approximation polynomial.

The memory may further store a depth consumption condition of the neural network operation.

The instructions may be further configured to cause the one or more processors to, for each of the layers, determine a degree combination of the approximation polynomial that minimizes the error while satisfying the depth consumption condition.

The neural network operation may include a rectified linear unit (ReLU) function.

The instructions may be further configured to cause the one or more processors to determine, based on the layer importances, a modulus chain corresponding to the layers

Other features and aspects will be apparent from the following detailed description, the drawings, and the claims.

### BRIEF DESCRIPTION OF THE DRAWINGS

FIG. 1 illustrates an example neural network operation apparatus, according to one or more embodiments.

FIG. 2 illustrates an example process of the neural network operation apparatus of FIG. 1 to generate an approximation polynomial, according to one or more embodiments.

FIG. 3 illustrates an example process of generating an approximation polynomial, according to one or more embodiments.

FIG. 4 illustrates an example method of determining a degree of an approximation polynomial, according to one or more embodiments.

FIG. 5 illustrates an example method of calculating a mean squared error function for a ReLU function, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

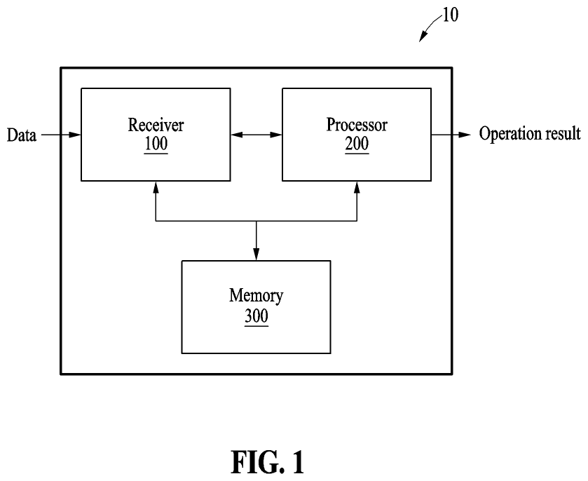

FIG. 1 illustrates an example neural network operation apparatus, according to one or more embodiments.

Referring to FIG. 1, a neural network operation apparatus 10 may perform a neural network operation. A neural network operation may include an operation performed when training or a neural network or when performing inference with a neural network.

The neural network operation apparatus 10 may perform a neural network operation on homomorphically encrypted data (data encrypted according to a homomorphic encryption scheme, generally, fully homomorphic). Homomorphic encryption refers to a method of encryption that allows various operations to be performed on encrypted data(ciphertext). In a homomorphic encryption scheme, a given operation on a ciphertext may transform the ciphertext into a new ciphertext. However, a plaintext obtained by decrypting the transformed-ciphertext may be the same as if the given operation had been performed on the plaintext of the original ciphertext.

The neural network model may be trained to have the general ability to solve a problem, where nodes are interconnected to form the network and weights of the interconnections may be changed through training. Generally, the neural network model may have layers of nodes, each layer's nodes having weighted connections to nodes of an adjacent node layer.

The nodes of the neural network model may include a combination of weights or biases. As noted, the neural network model may include layers, each including one or more nodes. The neural network model may infer a result from an input by weights of the nodes, which may be changed to a purpose through training.

The neural network model may be, for example, a deep neural network (DNN). The neural network model may be/include, for example, a convolutional neural network (CNN), a recurrent neural network (RNN), a perceptron, a multilayer perceptron, a feed forward (FF) network, a radial basis network (RBF), a deep feed forward (DFF) network, a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), and/or an attention network (AN).

The neural network operation apparatus 10 may be implemented in a personal computer (PC), a data server, or a portable device. Although the term “neural network operation apparatus” is used throughout this disclosure, the term does not imply a monolithic embodiment or implementation. Rather the term stands in the place of any variety of types of apparatuses configured to perform any of the examples or embodiments described herein.

In the case of the neural network apparatus 10 being a portable device, the apparatus may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, a smart device, or the like. A smart device may be implemented as a smart watch, a smart band, or a smart ring, for example.

The neural network operation apparatus 10 may perform a neural network operation using an accelerator device. Specifically, a neural network operation may be specifically performed by an accelerator. The neural network operation apparatus 10 may be implemented as part of, or in combination with, the accelerator.

The accelerator may be implemented as, for example, a neural processing unit (NPU), a graphics processing unit (GPU), a field-programmable gate array (FPGA), an application-specific integrated circuit (ASIC), or an application processor (AP). Alternatively, the accelerator may be implemented as a software computing environment such as a virtual machine, a container, or the like.

The neural network operation apparatus 10 includes a receiver 100 and a processor 200. The neural network operation apparatus 10 may further include a memory 300.

The receiver 100 may be, for example, a receiving interface. The receiver 100 may receive data. The receiver 100 may receive data from an external device or the memory 300. The receiver 100 may output received data to the processor 200. The receiver 100 may be a network interface, a bus interface, a wireless interface, or the like.

The receiver 100 may receive data for performing a neural network operation and a parameter for generating an approximation polynomial corresponding to the neural network operation.

The data for performing a neural network operation may include input data (data to be input to the neural network) or a layer configuring the neural network. The parameter for generating an approximation polynomial may include a degree of the approximation polynomial and a depth consumption condition of the neural network operation. The neural network operation may include a non-linear function operation. For example, the neural network operation may be/include a rectified linear unit (ReLU).

The processor 200 may process data stored in the memory 300. The processor 200 may process data stored in the memory 300. The processor 200 may execute computer-readable code (for example, software) stored in the memory 300 and instructions triggered/generated by the processor 200.

The processor 200 may be a data processing device implemented by hardware including a circuit having a physical structure to perform desired operations. For example, the desired operations may include code or instructions included in a program.

The hardware-implemented data processing device may be/include, for example, a microprocessor, a central processing unit (CPU), a processor core, a multi-core processor, a multiprocessor, an application-specific integrated circuit (ASIC), and/or a field-programmable gate array (FPGA).

The processor 200 may obtain layer information corresponding to layers of the neural network based on the data, may determine layer importances (measures/scores) respectively corresponding to the layers and may do so based on a parameter and the layer information. The processor 200 may generate approximation polynomials approximating a neural network operation for the respective layers, and may generate an operation result by performing the neural network operation based on the approximation polynomials.

The processor 200 may determine the degree of the approximate polynomial based on the layer importance scores/measures.

The processor 200 may calculate a mean and a standard deviation of input data of a layer of the neural network based on the data.

The processor 200 may calculate an error between the neural network operation and the approximate polynomial based on the parameter, the mean, and the standard deviation, and may determine the approximation polynomial for each layer that minimizes the error with the neural network operation under certain conditions. For example, the approximation polynomial approximate a ReLU function.

The processor 200 may calculate a mean squared error between a result of the neural network operation (e.g., an inference) and a result determined by the approximation polynomial (e.g., using a weighted least square).

For each of the layers, the processor 200 may determine a combination of degrees of the approximation polynomial to minimize an error under a computation time condition that can be tested against a time taken for the neural network operation based on the approximation polynomial.

For the layers, the processor 200 may determine a combination of degrees of respective approximation polynomials to minimize an error under the depth consumption condition.

The processor 200 may determine a modulus chain corresponding to each of the layers based on the layer importance.

The memory 300 stores instructions (or programs) executable by the processor 200. For example, the instructions may include instructions for performing the operation of the processor 200 and/or an operation of each component of the processor 200.

The memory 300 may be implemented as a volatile or non-volatile memory device (but not a signal per se).

In the case of volatile memory, the memory 300 may be implemented as dynamic random-access memory (DRAM), static random-access memory (SRAM), thyristor RAM (T-RAM), zero capacitor RAM (Z-RAM), or twin transistor RAM (TTRAM), to name some examples.

In the case of non-volatile memory, the memory 300 may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, or insulator resistance change memory.

The neural network operation apparatus 10 may be installed in a system including a non-arithmetic function (among possible arbitrary operations) operated for fully homomorphic encrypted data. The neural network operation apparatus 10 may be installed in various deep learning services (e.g., cloud services) that include a non-arithmetic function; which may be done using a Cheon-Kim-Kim-Song (CKKS) scheme among full homomorphic encryptions.

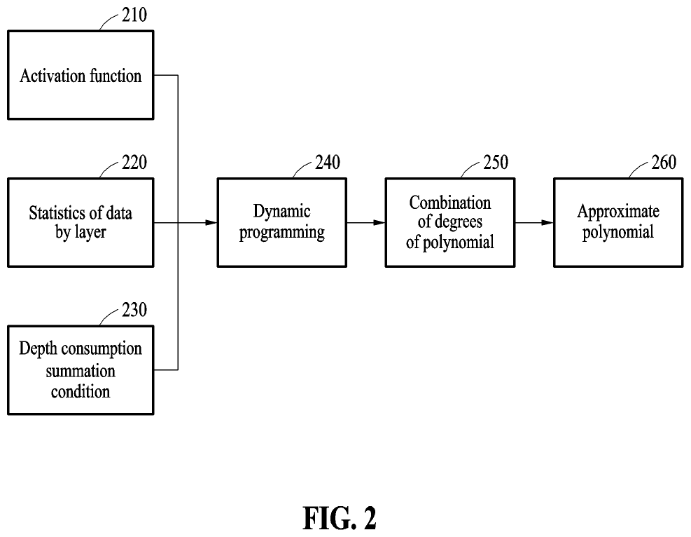

FIG. 2 illustrates an example process of the neural network operation apparatus of FIG. 1 to generate an approximation polynomial, according to one or more embodiments.

Although conventionally, in performing deep learning for fully homomorphic encrypted data, a method of accurately approximating a non-arithmetic function (e.g., a function unable to be computed with polynomial addition and multiplication) exists, the method of approximating a polynomial regardless of the accuracy of a deep learning model in which the polynomial is installed may be used.

Conventionally, a deep learning operation may be performed by approximating a ReLU function of each layer, where the ReLU function is required for performing deep learning to polynomials of the same degree.

For example, in a conventional method, where a polynomial is used for approximating an activation function that is frequently used by an actual deep learning model (e.g., a ReLU function), the polynomial may be designed to perform deep learning for fully homomorphic encrypted data. However, with this method it has not been possible to determine a degree of the polynomial considering the accuracy of each layer, and performance is highly sensitive to the degree of the polynomial; unnecessary degree of the polynomial can create high and unnecessary computation demand. Even a theoretical method of determining a degree that optimizes the depth consumption has not been devised.

A processor (e.g., the processor 200 of FIG. 1) according to one or more embodiments may perform a neural network operation on fully homomorphic encrypted data. The processor 200 may approximate a non-arithmetic function (e.g., a ReLU function) included in the neural network operation. The processor 200 may effectively approximate a ReLU function with a polynomial by considering a distribution of input data for each layer. The ReLU may be expressed by ReLU(x)=max{x, 0}.

When approximating a non-arithmetic function for fully homomorphic encrypted data, the neural network operation apparatus 10 may more efficiently control/adjust depth consumption by flexibly setting a degree of an approximation polynomial for each layer based on a data value passing through the neural network.

More specifically, the neural network operation apparatus 10 may consider a feature of each layer when approximating an activation function to a polynomial for fully-homomorphic encrypted data, and more particularly, may obtain a combination of polynomial degrees for the respective layers that minimizes a mean squared error of result values caused by approximation of the polynomials under the depth consumption condition determined by a user.

In the present disclosure, a case in which an activation function ƒ(x) is to be approximated, the following may be considered: a mean μ and a standard deviation σ of statistics of input data to the activation function. When a degree d of the polynomial is provided, the neural network operation apparatus 10 may design/configure a polynomial that minimizes a mean squared error between the activation function ƒ(x) and the polynomial. Hereinafter, the number of activation functions (for respective layers) to be approximated may be L, and for i that is 1≤i≤L, an activation function applied to an i-th layer may be ƒᵢ(x), x being the input data to the activation function at the i-th layer.

Hereinafter, an activation function applied to the i-th layer may be referred to as ƒᵢ(x), a mean of input values to the activation function ƒᵢ(x) may be referred to as μᵢ, a standard deviation thereof may be referred to as σᵢ, and a distribution of input values may be referred to as Equation 1 shown below.

$${ϕ}_{i} ( x ) = \frac{1}{\sqrt{2 {πσ}_{i}^{2}}} exp ( - \frac{{( x - {μ}_{i} )}^{2}}{2 {σ}_{i}^{2}} ) \qquad Equation l$$

Hereinafter, when a degree d of a polynomial p(x) is given, a polynomial in which Equation 2 (mean squared error) is minimized due to approximation of the polynomial in each layer may be referred to as p_{i,d}(x).

$${\int }_{- ∞}^{∞} {ϕ}_{i} ( x ) {( {f}_{i} ( x ) - p ( x ) )}^{2} d x \qquad Equation 2$$

Hereinafter, when using a polynomial p_{i,d}(x), a mean squared error caused by polynomial approximation in each layer (an i-th layer) may be referred to as MSEᵢ(d), and a degree of a polynomial set by the i-th layer may be referred to as dᵢ. Given this degree dᵢ of an approximation polynomial of an activation function used by the i-th layer, a time taken for computing the corresponding layer may be defined as T(dᵢ).

In this case, the total time taken for a neural network operation (e.g., an inference) to be performed based on approximation polynomials may be defined as a computation time condition T, and the total time taken for the neural network operation based on the approximation polynomials may be defined by Equation 3.

$${\sum }_{i} ⌈ T ( {d}_{i} ) ⌉ = {\sum }_{i} ⌈ c e i l ( log ( {d}_{i + 1} ) ⌉ \qquad Equation 3$$

The neural network operation apparatus 10 may provide, through dynamic programming, a method of minimizing a value of Equation 4, which is the sum of mean squared errors at the respective layers (i.e., the error of a final result value) when the total time taken for the neural network operation based on the approximation polynomials does not exceed T.

$$M S {E}_{1} ( {d}_{1} ) + M S {E}_{2} ( {d}_{2} ) + … + {MSE}_{L} ( {d}_{L} ) \qquad Equation 4$$

The neural network operation apparatus 10 may determine a minimum degree d in which a mean squared error value (refer to Equation 2) obtained by approximating the activation function ƒᵢ(x) to the polynomial p_{i,d}(x) is less than E, and the minimum degree may be referred to as dᵢ. In other words, the neural network operation apparatus 10 may determine the combination of (d₁, d₂, . . . , d_{L}) that can minimize the error.

In one example, the neural network operation apparatus 10 may determine a degree of the approximation polynomial for each respective layer based on a summation condition of depth consumption D.

When a user sets a degree of the polynomial in the i-th layer to be dᵢ, a sum of depth consumed by an activation function operation while performing total deep learning may be defined as Equation 5.

$${\sum }_{i} ⌈ {log}_{2} ( {d}_{i} + 1 ) ⌉ \qquad Equation 5$$

The neural network operation 10 may provide, through dynamic programming, a method of minimizing a value of Equation 4 (a mean squared error value of a final result value) when a value of a sum of depths consumed by an activation function operation does not exceed D.

The neural network operation apparatus 10 may determine a minimum degree d for which a mean squared error value (refer to Equation 2) obtained by approximating the activation function ƒᵢ(x) to the polynomial p_{i,d}(x) is less than E, and such minimum degree may be referred to as dᵢ.

The neural network operation apparatus 10 may determine a polynomial degree 250 optimized to data by performing dynamic programming 240 on a given activation function 210, based on statistics 220 (e.g., a mean and a standard deviation) of data input to each layer and a depth consumption summation condition 230. Thereafter, the neural network operation apparatus 10 may determine an approximation polynomial 260 to be applied to an entire model through an optimal solution of a combination of the obtained polynomial degree 250.

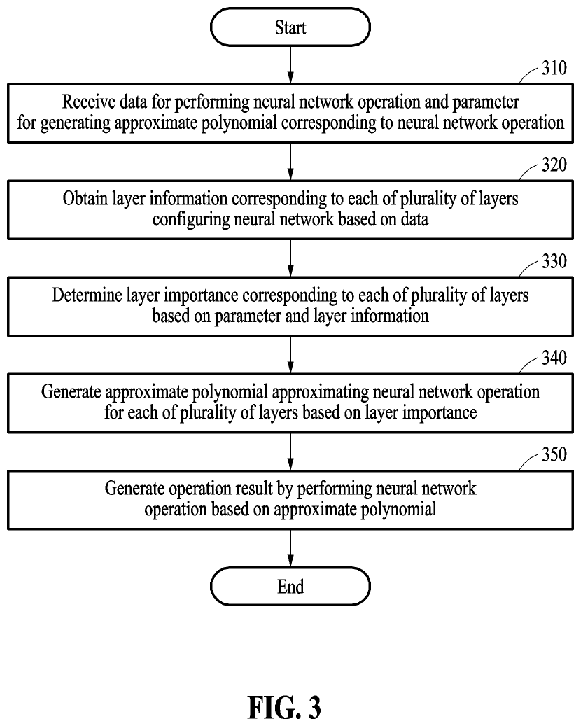

FIG. 3 illustrates an example process of generating an approximation polynomial according to one or more embodiments.

For ease of description, it operations 310 to 350 are described as performed using the neural network operation apparatus 10 of FIG. 1. However, operations 310 to 350 may be performed by another suitable electronic device in any suitable system.

Referring to FIG. 3, in operation 310, a receiver 100 may receive data for performing a neural network operation and a parameter for generating an approximation polynomial corresponding to the neural network operation. The parameter may be/include (or be proportional to) a computation time condition (e.g., limit) of the neural network operation.

In operation 320, the processor 200 may obtain layer information corresponding to respective layers of a neural network based on the data.

In operation 330, the processor 200 may determine layer importances of the respective layers based on the parameter and the layer information.

In operation 340, the processor 200 may generate an approximation polynomial approximating a neural network operation for each of the plurality of layers based on the layer importance. The processor 200 may determine the degree of the approximation polynomial based on the layer importance.

More specifically, the neural network operation apparatus 10 may maximize the efficiency of an operation (e.g., activation function) by allocating different degrees to respective layers by considering the importance of each layer. For example, in a more important layer, the neural network operation apparatus 10 may more greatly minimize an error using a higher order polynomial, and in a less important layer, the neural network operation apparatus 10 may allow a predetermined level of error using a low order polynomial, and thereby may increase the operation efficiency.

In one embodiment, the neural network operation apparatus 10 may calculate a difference between a non-linear function (e.g., an activation function) for each layer and a corresponding approximation polynomial approximating the non-linear function, and based thereon, may determine the importance of the layer. For example, as described with reference to FIG. 2, the processor 200 may calculate a mean and a standard deviation of input data of a layer of a neural network, may calculate an error between a neural network operation and an approximation polynomial based on the mean and the standard deviation, and may determine a degree combination of the approximation polynomial that may minimize an error under the computation time condition for each of the plurality of layers.

In another embodiment, the neural network operation apparatus 10 may consider, in each layer, an effect of an approximation error on classification accuracy, and may thus quantify the importance of each layer.

More specifically, a relationship between two terms may be used to identify a relationship between an approximation error and classification accuracy. When a loss function is minimized in a pre-trained model for plaintext, a loss function value in which an approximation error has occurred may further increase. When the increment (increase in error) is referred to as loss noise, the loss noise may have a negative effect on the classification accuracy, and thus, to minimize the effect, a variance of the loss noise may be used as a surrogate function of the classification accuracy.

Regarding loss, [symbol] ({a_{i,j}}) denotes a loss function, a_{i,j} denotes a j-th node of an i-th layer, Δa_{i,j} denotes an error due to polynomial approximation, and Δ [symbol] := [symbol] ({a_{i,j}+Δa_{i,j}})− [symbol] ({a_{i,j}}) denotes loss noise.

In this case, a variance of the loss noise may be expressed by Equation 6 shown below through Taylor approximation.

$$Var [ Δ ℒ ] = {\sum }_{i , j} {( \frac{\partial ℒ}{\partial {a}_{i , j}} )}^{2} Var [ Δ {a}_{i , j} ] = {\sum }_{i} {α}_{i} {E}_{μ i , {σ}_{i}^{2}} [ {d}_{i} ; f ] \qquad Equation 6$$

In Equation 6, Δa_{i,j} is an error due to polynomial approximation and may be expressed as a mean squared error.

$${α}_{i} = {\sum }_{j} {( \frac{\partial ℒ}{\partial {a}_{i , j}} )}^{2}$$

may be a value obtained by quantifying an effect of an i-th layer to classification accuracy. When Aᵢ is a mean of aᵢ for multiple pieces of data, a variance of loss noise may be expressed by Var[Δ [symbol] ]=ΣᵢAᵢE_{μ}_{ᵢ}_{,σ}_{ᵢ}_{²}[dᵢ; ƒ] and an optimization equation in N_{L} layers may be expressed by Equation 7 shown below.

$${min}_{{d}_{1} , … , {d N}_{L}} {\sum }_{i = 1}^{{N}_{L}} {A}_{i} E [ {d}_{i} ; f ] subject to {\sum }_{i = 1}^{{N}_{L}} {T}_{i} ( {d}_{i} ) \leq K \qquad Equation 7$$

Equation 7 relates to an optimization issue for minimizing loss noise when a sum of degrees is given. In this case, the given sum of degrees may be quantified as time, where K denotes an inference time constraint (a maximum time allowed to perform an inference), and Tᵢ(dᵢ) denotes a required time for polynomial approximation in the i-th layer and bootstrapping.

Since an optimal solution may be difficult to obtain due to the lack of closed-form expression of

$${T}_{i} ( {d}_{i} ) , {T}_{i}^{Rel , v} ( {d}_{i} ) := \frac{1}{v} \cdot round ( {T}_{i} ( {d}_{i} ) \cdot v )$$

may be defined by discrete relaxation of Tᵢ(dᵢ) and an optimization problem may be designed as Equation 8 shown below.

$${min}_{{d}_{1} , … , {d}_{l}} {\sum }_{i = 1}^{l} {A}_{i} E [ {d}_{i} ; f ] subject to {\sum }_{i = 1}^{l} {T}_{i}^{Rel , v} ( {d}_{i} ) \leq k \qquad Equation 8$$

In operation 350, the processor 200 may generate an operation result by performing the neural network operation based on the approximation polynomial.

Furthermore, the processor 200 may determine a modulus chain corresponding to each of the layers based on the layer importances.

When the same modulus chain is used for all layers, the size of input data for bootstrapping may be greater than an optimal size, thereby runtime may significantly increase. Accordingly, the processor 200 may optimize bootstrapping runtime by using a different modulus chain for each layer, since a different depth is used for each activation function.

When the depth of an approximation polynomial for an activation function of a layer is l<lₘₐₓ, in a modulus chain for the corresponding layer, a modulus q₀, q₁, qₗ_{_{conv}}₊ₗ, q_{δ+1}, . . . , q_{L} may be sufficient for an evaluation modulus. In this case, since a bootstrapping operation does not need to compute, for a modulus, qₗ_{_{conv}}₊ₗ, . . . , q_{δ}, runtime of the bootstrapping may decrease.

When a ciphertext level is 0 and a modulus needs to be raised for next bootstrapping, the processor 200 may select a modulus chain to be used in a next layer.

Since a coefficient of a secret key is only from the set of {−1, 0, 1}, the secret key may be independent of the modulus, and various modulus chains may be sequentially used for one ciphertext encrypted with one secret key.

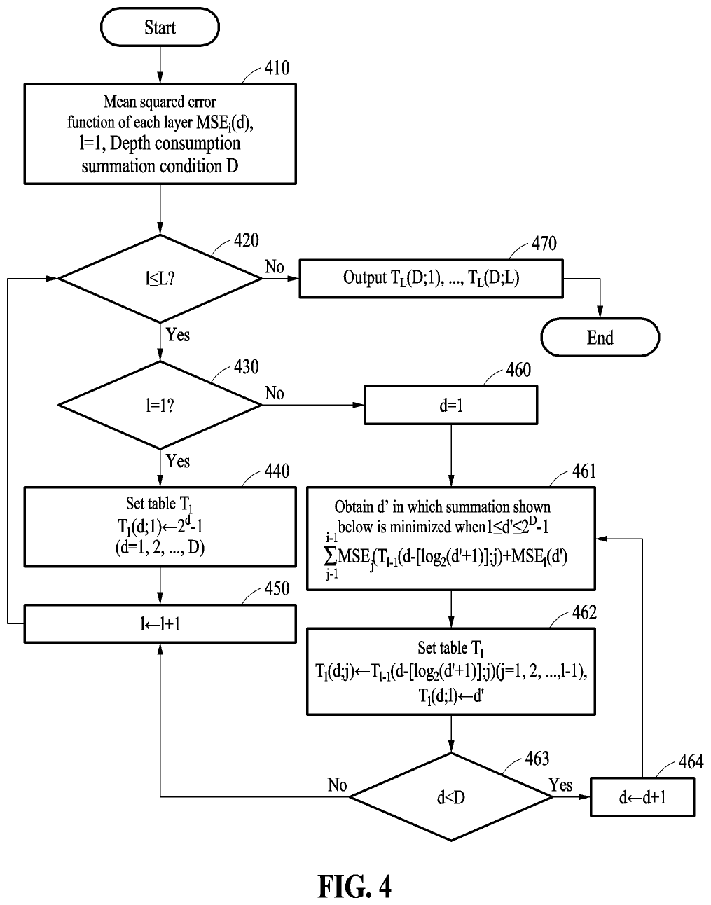

FIG. 4 illustrates an example of a method of determining a degree of an approximation polynomial according to one or more embodiments.

Referring to FIG. 4, when a mean squared error function MSEᵢ(d) is given in each layer (the i-th layer), operations 410 to 470 may be related to a method of minimizing a sum ΣᵢMSEᵢ(dᵢ) of mean squared errors (under a condition of Σᵢ┌log₂(dᵢ+1)┐≤D) using dynamic programming. However, although the description is provided based on the condition of Σᵢ┌log₂(dᵢ+1)┐≤D in FIG. 4, the condition according to one embodiment is not limited thereto. For example, the description with reference to FIG. 4 may be identically applied to a method of minimizing a sum ΣᵢMSEᵢ(dᵢ) of mean squared errors under a condition Σᵢ┌T(dᵢ)┐≤T.

A core dynamic programming technique is recursively solving an optimization problem, and next, an optimization “problem-l” may be defined as follows.

Problem-l: outputting a combination of degrees {d₁, . . . , dᵢ} in which MSE₁(dᵢ)+ . . . +MSEₗ(dₗ) is minimized under a condition of a sum of given depth consumptions, in other words, in which a sum of consumed depths is less than or equal to d when a degree is set to be d₁, . . . , dₗ, in other words, a condition of ┌log₂(d₁+1)┐+ . . . +┌log₂(dₗ+1)┐≤d.

Hereinafter, “Table Tₗ” is defined as a space in which an optimal solution of a degree of the problem-l is stored. In Tᵢ(d; 1), . . . , T₁(d; l), an optimal solution d₁, . . . , dₗ may be sequentially stored under a condition ┌log₂(d₁+1)┐+ . . . +┌log₂(dₗ+1)┐≤d of the problem-l. In this case, 1≤d≤D may be satisfied.

A dynamic programming goal may be to obtain a final value of a combination T_{L}(D; 1), T_{L}(D; 2), . . . , T_{L}(D; L) of degrees, after recursively filling the table with respect to l to ultimately fill an optimal solution into Table Tᵢ.

Hereinafter, Tₗ(d; 1), Tₗ(d; 2), . . . , Tₗ(d; l) may be denoted in short as Tₗ(d; ⋅). Firstly, when filling T₁(d; ⋅) with respect to all 1≤d≤Ds when l=1, and recursively obtaining Tₗ₋₁(d; ⋅) with respect to all 1≤d≤Ds, a value of Tₗ(d; ⋅) may be obtained using this value.

When a degree dₗ of an l-th layer is to be determined, MSEₗ(dₗ) may be a constant and the problem-l may become the problem of obtaining a combination of degrees to minimize MSE₁(d₁)+ . . . +MSEₗ₋₁(dₗ₋₁) under a condition of Equation 9 shown below, and this may be the same as obtaining Tₗ(d−┌log₂(dₗ+1)┐; ⋅) in a problem-(l−1).

$$⌈ {log}_{2} ( {d}_{1} + 1 ) ⌉ + … + ⌈ {log}_{2} ( {d}_{l - 1} + 1 ) ⌉ \leq d - ⌈ {log}_{2} ( {d}_{l} + 1 ) ⌉ \qquad Equation 9$$

To obtain a value of Table Tₗ, Tₗ(d; ⋅) may be set to be Tₗ₋₁(d−┌log₂(d′+1)┐; 1), Tₗ₋₁(d−┌log₂(d′+1)┐; 2), . . . , Tₗ₋₁(d−┌log₂(d′+1)┐; l−1), d′ with respect to all 1≤d≤Ds and d′=argmin_{1≤d}_{ₗ}_{≤2}_{^{D}}₋₁[Σⱼ₌₁^{l-1}MSEⱼ(Tₗ₋₁(d−┌log₂(dᵢ+1)┐; j)+MSEₗ(dₗ)]s. T_{L}(D; ⋅) may be obtained using dynamic programming by repeating this process recursively until 1=L is satisfied.

More specifically, in operation 410, the processor 200 may obtain a mean squared error function of each layer and a condition of a sum of depth consumptions. In operation 420, the processor 200 may compare l with L, and when l is less than or equal to L and l is 1, in operation 440, may set Table T₁.

In operations 450, 460, 461, 462, 463, 464, and 470, the processor 200 may recursively fill the table with respect to l to fill an optimal solution into Table Tₗ while increasing a value of l, and then, finally, may determine a value of a combination T_{L}(D; 1), T_{L}(D; 2), . . . , T_{L}(D; L) of degrees.

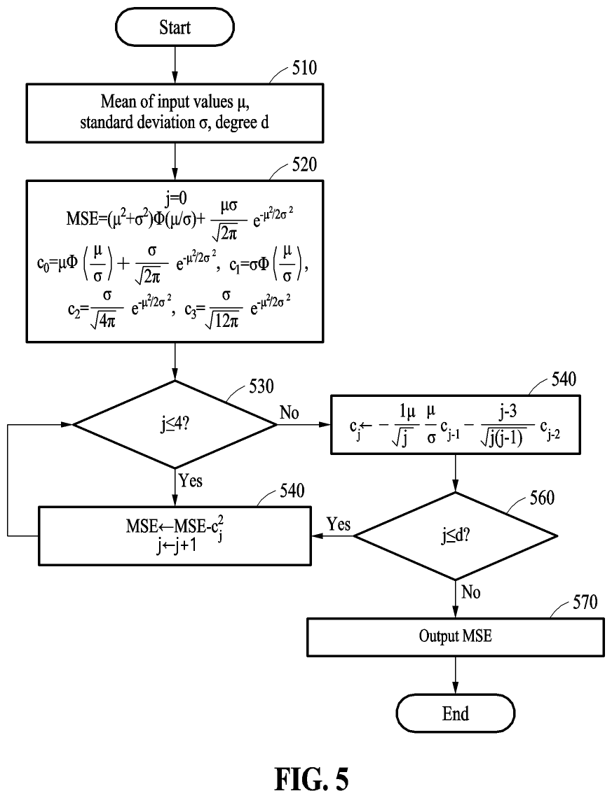

FIG. 5 illustrates an example of calculating a mean squared error function for a rectified linear unit (ReLU) function according to one or more embodiments.

FIG. 5 shows a method of calculating a value of MSE in the case in which MSE is minimized when a ReLU function is approximated to a d-th degree polynomial. The ReLU function ReLU(x) may represent max{x, 0}. The processor 200 may approximate a distribution of input values with a weight of

$$ϕ ( x ) = \frac{1}{\sqrt{2 {πσ}^{2}}} exp ( - \frac{{( x - μ )}^{2}}{2 {σ}^{2}} ) .$$

In operation 510, the processor 200 may receive a mean, a standard deviation, and a degree of input values.

In operation 520, the processor 200 may set j to be “0” and may calculate MSE, c₀, c₁, c₂, c₃.

In operation 530, the processor 200 may determine whether j is less than or equal to 4. When j is less than or equal to 4, in operation 540, the processor 200 may update MSE−cⱼ² with MSE, may increase a value of j, and may iteratively perform the operation for all js.

When j is not less than or equal to 4, in operation 550, the processor 200 may update

$$- \frac{1}{\sqrt{j}} \frac{μ}{σ} {C}_{j - 1} - \frac{j - 3}{j ( j - 1 )} {C}_{j - 2}$$

with cⱼ₋₂, and in operation 560, may compare with d; when j is less than or equal to d, the processor 200 may proceed to operation 540, and when j is not less than or equal to d the processor 200 may output a mean squared error in operation 570.

Although much of the description above is in mathematical notation, it will be appreciated that such mathematical notation is shorthand replacement for equivalent, but overly cumbersome, English description. The mathematical notation above is not the direct subject matter claimed herein. Rather, the mathematical notation concisely describes operations to be performed by processing hardware. One may readily translate the mathematical notation to equivalent source code that may be compiled to produce machine-executable instructions that, when executed by a processor, cause the processor to physical operations equivalent to those described by the mathematical notation. Similarly, such notation may be readily translated to the language of circuit design tools that may generate circuit designs that perform operations described by the mathematical notation.

The computing apparatuses, the electronic devices, the processors, the memories, the displays, the information output system and hardware, the storage devices, and other apparatuses, devices, units, modules, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An operation method of performing a neural network operation, of a neural network model, on homomorphically encrypted data, the operation performed by a computing device, method comprising:
receiving data for performing the neural network operation and receiving a parameter for generating an approximation polynomial corresponding to the neural network operation;
obtaining layer information corresponding to layers of the neural network model, the layer information based on the data;
determining importances of the layers, respectively, wherein the determining of the importances is based on the parameter and the layer information;
generating an approximation polynomial approximating the neural network operation for each of the layers, wherein the generating is based on the layer importance; and
generating an operation result by performing the neural network operation based on the approximation polynomial,
wherein the parameter comprises a computation time condition that the neural network operation must satisfy.

2. The operation method of claim 1, wherein the generating of the approximation polynomial comprises determining a degree of the approximation polynomial based on the layer importances.

3. The operation method of claim 1, wherein the obtaining of the layer information comprises calculating, based on the data, a mean and a standard deviation of input data of a layer of the neural network model.

4. The operation method of claim 2, wherein the determining of the layer importances comprises:
calculating an error between the neural network operation and the approximation polynomial based on the parameter, the mean, and the standard deviation; and
determining a degree of the approximation polynomial based on the error.

5. The operation method of claim 4, wherein the calculating of the error comprises calculating a mean squared error between the neural network operation and the approximation polynomial using a weighted least square.

6. The operation method of claim 4, further comprising determining whether the time condition is satisfied based on a time consumed for the neural network operation, which is determined based on the approximation polynomial.

7. The operation method of claim 6, wherein the determining of the degree of the approximation polynomial comprises, for each of the layers, determining a corresponding degree of the approximation polynomial that minimizes the error while satisfying the computation time condition.

8. The operation method of claim 4, wherein the parameter comprises a depth consumption condition of the neural network operation.

9. The operation method of claim 8, wherein the neural network operation comprises an activation function.

10. The operation method of claim 1, wherein the neural network operation comprises a rectified linear unit (ReLU) function.

11. The operation method of claim 1, further comprising:
determining a modulus chain corresponding to the layers based on the layer importances.

12. A non-transitory computer-readable storage medium storing instructions that, when executed by a processor, cause the processor to perform the operation method of claim 1.

13. An operation apparatus for performing a neural network operation of a neural network model on homomorphically encrypted data, the operation apparatus comprising:
one or more processors;
memory storing data for performing the neural network operation, a parameter for generating an approximation polynomial for approximating the neural network operation, and instructions configured to cause the one or more processors to:
obtain, based on the data, layer information corresponding to layers of the neural network model;
determine, based on the parameter and the layer information, layer importances respectively corresponding to the layers;
generate an approximation polynomial approximating the neural network operation for each of the plurality of layers, based on the layer importance; and
generate an operation result by performing the neural network operation based on the approximation polynomial;
wherein the parameter comprises a computation time condition that is to be satisfied for the neural network operation.

14. The operation apparatus of claim 13, wherein the instructions are further configured to cause the one or more processors to determine, based on the layer importances, a degree of the approximation polynomial.

15. The operation apparatus of claim 13, wherein the instructions are further configured to cause the one or more processors to calculate a mean and a standard deviation of input data of a layer of the neural network, the input data based on the data.

16. The operation apparatus of claim 14, wherein the instructions are further configured to cause the one or more processors to:
calculate an error between the neural network operation and the approximation polynomial based on the parameter, the mean, and the standard deviation, and
determine a degree of the approximation polynomial based on the error.

17. The operation apparatus of claim 15, wherein the instructions are further configured to cause the one or more processors to calculate a mean squared error between the neural network operation and the approximation polynomial using a weighted least square.

18. The operation apparatus of claim 17, wherein the time condition is determined based on a time consumed for the neural network operation based on the approximation polynomial.

19. The operation apparatus of claim 13, wherein the memory further stores a depth consumption condition of the neural network operation.

20. The operation apparatus of claim 19, wherein the instructions are further configured to cause the one or more processors to, for each of the layers, determine a degree combination of the approximation polynomial that minimizes the error while satisfying the depth consumption condition.
